(19) United States
(12) Patent Application Publication
(10) Pub. No.: US 2011/0038173 A1
(43) Pub. Date: Feb. 17, 2011

(54) AMBIENT LIGHTING SYSTEM

(75) Inventor: Bradley Smithson, (US)

Correspondence Address: MITCHELL P. BROOK;LUCE, FORWARD, HAMILTON & SCRIPPS LLP, 600 West Broadway, Suite 2600, SAN DIEGO, CA, 92101, US

(73) Assignee: Pacific Insight Elctronics Corp., Nelson (CA)

(21) Appl. No.: 12/509,046

(22) Filed: Jul. 24, 2009

Related U.S. Application Data
(60) Provisional application No. 61/135,924, filed on Jul. 24, 2008.

(51) Int. Cl. G02B 6/04; G02B 27/10; G02B 5/04; G02B 6/38

(52) U.S. Cl. 362/554; 359/638; 385/58

(57) ABSTRACT

An optical prism comprising a first end adapted for input of light, a second end adapted for output of light and a plurality of sides forming a solid geometric structure. The sides are arranged at controlled angles to one another and have refracting surfaces to mix light. A plurality of outputs at the second end of the optical prism split light such that the light can be transmitted via a plurality of separate optic cables.

### CROSS-REFERENCE TO RELATED APPLICATION

This application claims priority to U.S. Provisional Patent Application Ser. No. 61/135,924, filed Jul. 24, 2008, which is incorporated herein by reference in its entirety.

### FIELD OF THE INVENTION

The present invention relates to LED lighting systems.

### BACKGROUND OF THE INVENTION

Commercially available Light Emitting Diodes (LEDs) often are found to provide different light intensities due to manufacturing variations. This deficiency can lead to color inconsistencies generated using red-green-blue (RGB) LED packages because of inconsistencies in the colors emitted—where one color may be dimmer than the others. For example, even if the red and green are similar part to part, the blue may be relatively dim in one part versus another. This can cause differences between two LED modules of the same model in the way that they display the same colors by using the same pulse width modulation (PWM) values to drive the RGB LED package. This can result in noticeable color inconsistencies where multiple RGB LED modules are used.

This deficiency is particularly apparent in motor vehicles. For example, in some motor vehicles, there are multiple LED lighted areas, such as cup rings, footwells, map pockets, and door latches. Since all LEDs are unique, and are visible in one area at one time any difference in LED color or intensity is noticeable. One attempted solution to this problem is to deliver ambient light within a vehicle using a master LED module with wires to multiple discrete printed circuit boards (PCBs) controls. However, this requires additional costs and power consumption and results in disparate light intensity and distribution.

In some known LED ambient lighting systems, an LED is placed behind a lens to diffuse and spread light in a desired manner. However, because the light source is at a distance behind the lens, light intensity is lost and an undesirable effect of light haloing occurs. In addition, the light can be split from a solid color into a rainbow of colors, reducing the intensity of the solid color. These deficiencies also are present in lighting systems having multiple components and multiple connections, such as vehicle lighting systems. In order to compensate for light losses, it can become necessary to select more powerful or expensive lighting systems than would be required if not for the light losses. In addition, a larger number of LEDs may be necessary to achieve a desired lighting level in order to compensate for transmission losses.

It is known to use glass optical fiber to transmit LED generated light. Plastic optical fiber (POF) is an alternative to glass optical fiber, but typically POF has a higher attenuation rate than glass optical fiber, i.e., the amplitude of the signal decreases more rapidly. This deficiency of POF frequently often leads designers to select glass fiber over plastic fiber. However, plastic optical fibers typically are a less expensive alternative and their generally larger diameters are more suitable for light transmission in a vehicle context. In addition, plastic optical fiber tends to be more durable, withstanding tighter bend radii than glass fiber.

Therefore, there exists a need for an LED lighting system using plastic optical fibers but having improved transmission efficiency that has a relatively even light intensity and reduced color variations, and which also allows for distribution of light from a single LED to multiple locations, particularly in motor vehicles. There is also a need for an optical prism that combines both a color mixing function and a distribution function into one component, thereby reducing the number of components and connections, including the number of LEDs, in the lighting system. There also exists a need for a component to effectively affix an optical prism to a circuit board at a light source and a component to effectively connect plastic optical fibers to an optical prism such that light is optimally transmitted and distributed with even intensity.

### SUMMARY OF THE INVENTION

The present invention alleviates to a great extent the disadvantages of known LED ambient lighting systems, by providing an ambient lighting system capable of distributing light from a single light source through plural strands of optic fiber, preferably POF, to end-light points. Generally speaking the present invention utilizes POF as a transmission medium for LED emitted light, and an optical prism that provides color mixing and optionally light direction. In one embodiment, colors are created using red-blue-green color mixing. It is one advantage of the invention that the number of components and connection points can be reduced and such that colors can be better matched in color and intensity. The lighting system's optical prism promotes a controlled splitting of the light emitted LEDs and facilitates the light connection of LEDs to multiple, preferably plastic, optical fibers.

In one aspect of the invention, a light engine, one or more plastic fiber optic cables and one or more light directing optics are provided. The light engine includes an optical prism in optical connection with at least one light-emitting diode, and which emits light comprising one or more colors. A module housing for the light engine also is provided, which may house the light-emitting diode, a circuit board, an endcap component, a connector housing and a fiber connector. The plastic fiber optic cables are in optical connection with the optical prism. The light directing optics are connected to the distal ends of the one or more plastic fiber optic cables and spread and direct light from the LED. These components operate together to respond to input requests for lighting and to mix, transfer and distribute light from the light-emitting diode(s) to the various locations to be lit with minimal loss and variation in light color and intensity.

In an embodiment, the module housing contains a light engine with at least one LED, an endcap component defining at least two recesses, and a circuit board. Various inputs including, but not limited to a vehicle ignition input, a battery input, a network input, controller area network (CAN) or local interconnect network (LIN), a color select, a zone select, a door input and a dimmer input, can be connected to the light engine. Internal software reads the inputs or color requests, and a microprocessor together with the internal circuitry of the light engine provide control over the LEDs. In a preferred embodiment, one recess of the endcap component is configured to receive the connector housing, and a second recess has an integrated electrical connector and/or electrical wiring. The endcap component may be removable or in the form of a hinged lid The LED is connected to the optical connector by conventional means, and the optical connector serves to connect the LED to the optical prism. In addition, the optical prism is housed in the optical connector. The LEDs feed emitted light comprising one or more colors into the optical prism.

In another aspect of the invention, the optical prism has a refracting structure to evenly mix and color match the colors in the LED light. In some embodiments, the optical prism has a hexagonal shape with six refracting surfaces arranged at 60 degree angles from each other, however other shapes and angles can be selected. In this embodiment, the hexagonal shape provides increased color mixing efficiency over a round shape. The emitted light bounces off the multiple refracting surfaces, which allow light to be picked up from various angles, increasing efficiency of light collection. In some embodiments, the optical prism includes outputs at a distal end that can provide multiple individual outputs, such as seven individual outputs. In other embodiments, different shapes can be used, and any number of outputs can be used, depending on the desired application. The refracting surfaces and inputs and outputs can be optimized to provide even color mixing and color matching and greater consistency in light intensity. In addition, combining color mixing, dividing and distribution into a single component such as the prism provides the advantage of reducing the number of optical elements that would be required if the functions were performed by multiple components.

In a preferred embodiment, a connector housing is provided to house the optical prism. The connector housing comprises a first end and a second end with a first opening at the first end and a second opening at the second end. The connector housing defines a passage therethrough and is substantially tapered such that the first end is smaller than the second end. The connector housing is disposed within one of the recesses of the endcap component such that the optical prism is adjacent the LED package and forms an optical connection therewith.

In another aspect of the invention, the multiple outputs feed the light from the optical prism into a fiber connector. The fiber connector has multiple slots configured to connect to a fiber bundle containing multiple plastic optical fiber cables. The number of color prism outputs and fiber connector slots varies according to the particular application. In some embodiments, three, seven and 19 outputs and slots may be used to ease the formation of a generally circular profile of the fiber bundle. The fiber connector may be made of nylon or any other suitable material known to those in the art.

In a further aspect of the invention, a connector housing is used to connect the fiber optic cables to the optical prism. In another aspect of the invention, the fiber optic cables are enclosed within a jacket, which is used to prevent light leakage and provides protection to the plastic optic fiber when routing and attaching in a desired location In another aspect of the invention, directing optics are provided at the distal ends of some or all of the optical fiber cables, providing additional ambient light direction in areas to be illuminated.

At least one light emitter or directing optic assembly is also provided to redirect light to the required direction of illumination. In one aspect of the invention, the directing optic assembly comprises an emitter assembly and a bezel assembly. The emitter assembly includes a first housing component and a second housing component. The bezel assembly includes a bezel and a gasket, which slides onto the bezel during assembly. A crimp barrel also is provided and defines a passage therethrough. The crimp barrel is attached to the end of a POF cable. The POF and the crimp barrel are held together in a the directing optic housing. The directing optic assembly also contains an optic lens, which transmits and directs light to the area to be illuminated.

In another aspect of the invention, the ambient lighting system provides input signals requesting light having specified color and intensity parameters; the light request is received in a particular light engine(s) for location(s) where illumination is desired. Optionally, a software operated controller receives the inputs and drives the LEDs accordingly, to provide the desired lighting characteristics. The light emitted from the LEDs is directed to the optical prism where the refracting surfaces mix the light to provide a relatively even intensity and predictable color. Electronics equipment including passive or active circuits, transistors, resistors or computer hardware and software also may be used to mix the colors. The mixed light is directed through the prism outputs, through the fiber connector to the optical fiber bundle. The light propagates through the fiber bundle to the distal ends of the cables where the directing optics direct the light illuminating desired locations with the intensity and color desired. These and other features and advantages of the present invention will be appreciated from review of the following detailed description of the invention, along with the accompanying figures in which like reference numerals refer to like parts throughout.

### BRIEF DESCRIPTION OF THE DRAWINGS

The foregoing and other objects of the invention will be apparent upon consideration of the following detailed description, taken in conjunction with the accompanying drawings, in which like reference characters refer to like parts throughout, and in which:

FIG. 1 is a block diagram showing an embodiment of the present invention.

FIG. 2 shows an embodiment of the invention including the plastic fiber optic cable and directing optic assemblies;

FIG. 3A shows an exploded view of a light engine of an embodiment of the present invention;

FIG. 3B shows an assembled light engine of an embodiment of the present invention;

FIG. 4A is a perspective view of an embodiment of a connector housing in accordance with the present invention;

FIG. 4B is a perspective view of an embodiment of a connector housing in accordance with the present invention;

FIG. 4C is a sectional view of an embodiment of a connector housing with an embodiment of an optical prism and an embodiment of a fiber connector in accordance with the present invention;

FIG. 4D is a front view of an embodiment of a connector housing with an embodiment of a fiber connector in accordance with the present invention;

FIG. 5A is a front isometric view of an embodiment of an endcap component in accordance with the present invention;

FIG. 5B is a back isometric view of an embodiment of an endcap component in accordance with the present invention;

FIG. 5C is a sectional view of an embodiment of an endcap component in accordance with the present invention;

FIG. 5D is a back view of an embodiment of an endcap component in accordance with the present invention;

FIG. 6 is an exploded view of an alternative embodiment of a light engine in accordance with the present invention

FIG. 7 is a perspective view of an embodiment of an optical prism and an embodiment of an LED package in accordance with the present invention;

FIG. 8 is a top view of an embodiment of an optical prism in accordance with the present invention;

FIG. 9 is a front view of an embodiment of an optical prism in accordance with the present invention;

FIG. 10 is a side view of an embodiment of an optical prism in accordance with the present invention;

FIG. 11 is a sectional view of an embodiment of an optical prism in accordance with the present invention;

FIG. 12 is a sectional view of an embodiment of an optical prism in accordance with the present invention;

FIG. 13 is a diagram of an embodiment of an RGB LED in accordance with the present invention;

FIGS. 14A and 14B comprise diagrams of an embodiment of a lighting system in accordance with the present invention;

FIGS. 15A, 15B, 15C and 15D comprise diagrams of an embodiment of a lighting system in accordance with the present invention;

FIGS. 16A and 16B comprise diagrams of an embodiment of a lighting system in accordance with the present invention;

FIG. 17 is a perspective view of an embodiment of a light engine circuit board attached to a platform in accordance with the present invention;

FIG. 18 is a perspective view of an embodiment of a light engine circuit board in accordance with the present invention;

FIG. 19 is a bottom perspective view of an embodiment of a light engine circuit board in accordance with the present invention;

FIG. 20 is a flow diagram showing the software layers of an embodiment of the lighting system software in accordance with the present invention;

FIG. 21 is a flow diagram showing the master module of an embodiment of the lighting system software in accordance with the present invention;

FIG. 22 is a flow diagram showing the slave module of an embodiment of the lighting system software in accordance with the present invention;

FIG. 23 is a perspective view of an embodiment of the lighting system in accordance with the present invention;

FIG. 24A is an exploded view of an embodiment of a cable connector assembly in accordance with the present invention;

FIG. 24B is a perspective view of an embodiment of a cable connector assembly in accordance with the present invention;

FIG. 25A is an exploded view of an embodiment of a directing optic assembly in accordance with the present invention; and

FIG. 25B is a perspective view of an embodiment of a directing optic assembly in accordance with the present invention.

### DETAILED DESCRIPTION OF THE INVENTION

In the following paragraphs, embodiments of the present invention will be described in detail by way of example with reference to the accompanying drawings. Throughout this description, the embodiments and examples shown should be considered as exemplars, rather than as limitations on the present invention. As used herein, the “present invention” refers to any one of the embodiments of the invention described herein, and any equivalents. Furthermore, reference to various aspects of the invention throughout this document does not mean that all claimed embodiments or methods must include the referenced aspects.

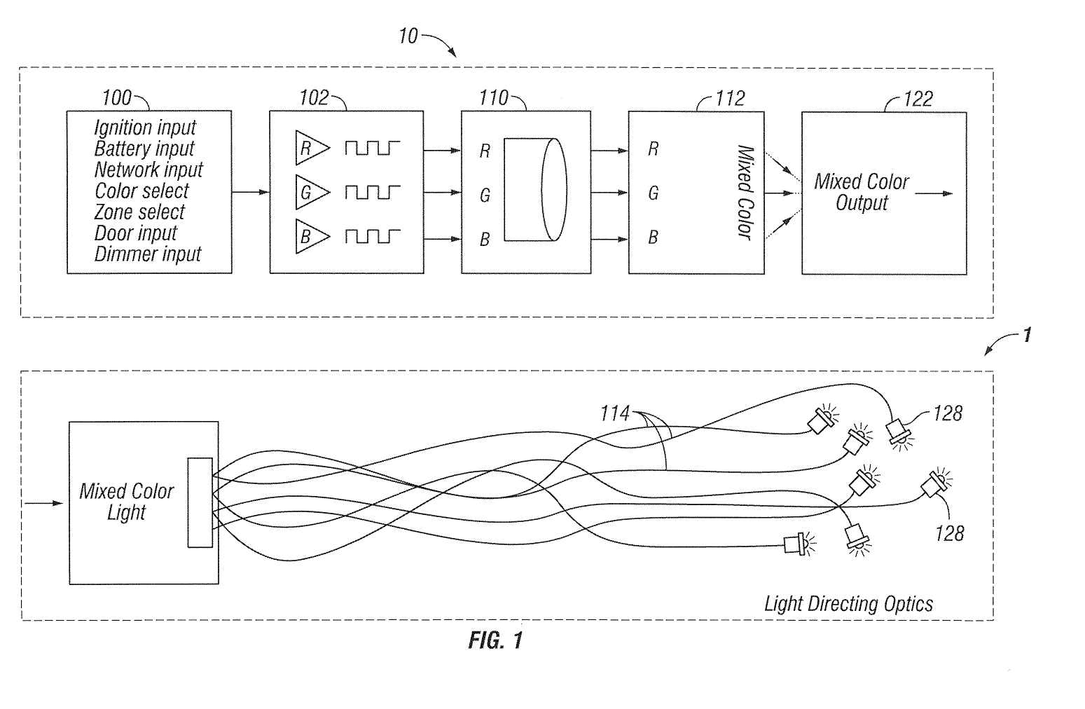

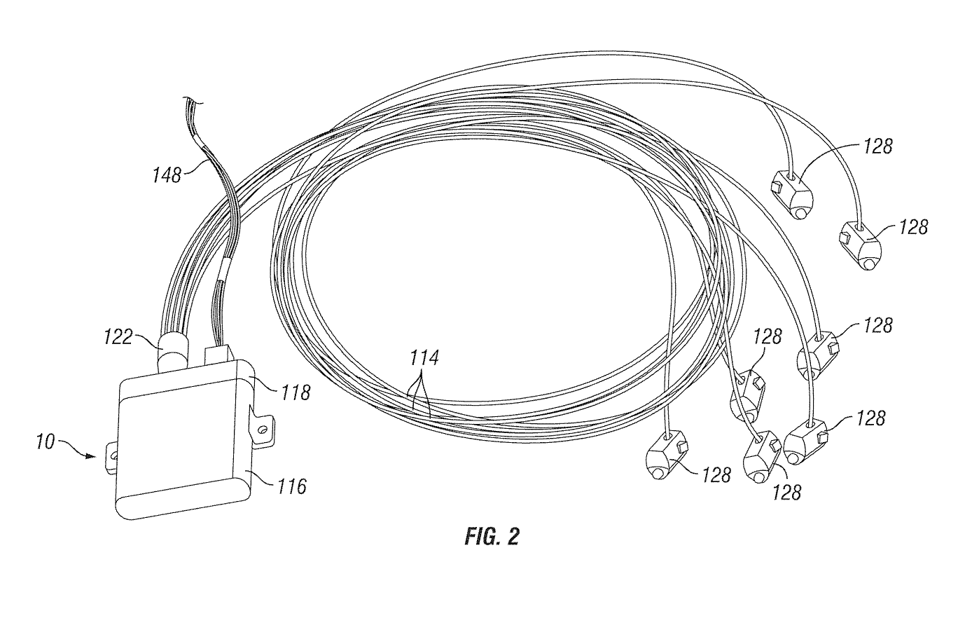

Referring to FIGS. 1-2, an illustration of components of an embodiment of lighting system 1 of the present invention is provided, including input circuitry 100, which provides the input signals for light engine 10. The light engine's internal circuitry 102 is electrically connected to the input circuitry 100. Lighting system 1 further comprises LED package 110, optical prism 112, fiber connector 122, optical fibers 114 and light directing optics 128. For illustrative purposes, the light engine internal circuitry 102 is shown connected to an RGB LED 110, but any other combination of or single LEDs also can be used, such as a single color LED or multiple LEDs of any desired colors. The LED light source may be a single color or a multiple color LED package. Light engine circuitry 102 also contains the light output functionality of LED package 110.

In some embodiments, directing optic assemblies 128 are provided at the distal ends of plastic optical fiber cables 114. The directing optic assemblies 128 direct emitted light as desired, such as to illuminate a particular location. In one example, the location illuminated is a portion of a vehicle. This distribution pathway will be discussed in more detail herein. In FIG. 2, one can see the entire length of the plastic fiber optic cables 114 and the directing optic assemblies 128 attached to the distal ends of the cables. The light output from the plastic optical fibers 114 is coupled to the light directing optic assemblies 128 to redirect light to the required direction of illumination. Wire bundle 148 provides inputs from the external circuitry (not shown) into the module housing 116 and module lid 118 assembly. The LED, electrical connector and optical prism are housed within the module housing 116 and cannot be seen in this figure.

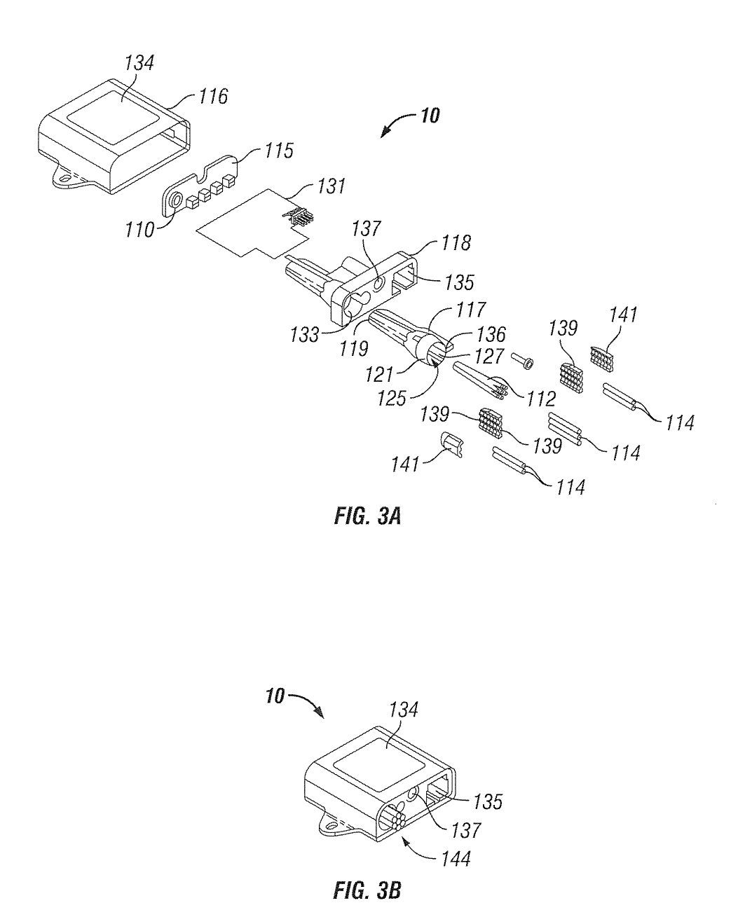

Light engine module housing 116 can contain any electronic controller suitable for controlling the light output of LED module 110 (referred to herein as LED 110 or LEDs 110), such as by providing desired voltage and current regulation, timing regulation or digital control in the case of digitally controlled LEDs. In some embodiments, RGB LEDs are used and in others, single color LEDs or LED arrays may be used. In other embodiments, multiple such LEDs are used. In the embodiment illustrated in FIGS. 3A-B, the light engine module housing 111 is operatively coupled to an RGB LED package 110. In a preferred embodiment, the light engine module housing 116 includes a computer processor controlled by on board software (optionally stored in a programmable memory). The light engine's internal circuitry 102 receives the input signals from the input circuitry 100, and interprets them as color requests, such as for various zones or features of a vehicle. It then provides output control signals to the LED package 110, which are interpretable to drive the LEDs to generate a desired color and brightness of light output. The software control within the module housing 116 can include any type of embedded controller software, while the entire signal communication system can be controlled by any suitable LIN, CAN or other type of communication and/or interfacing software.

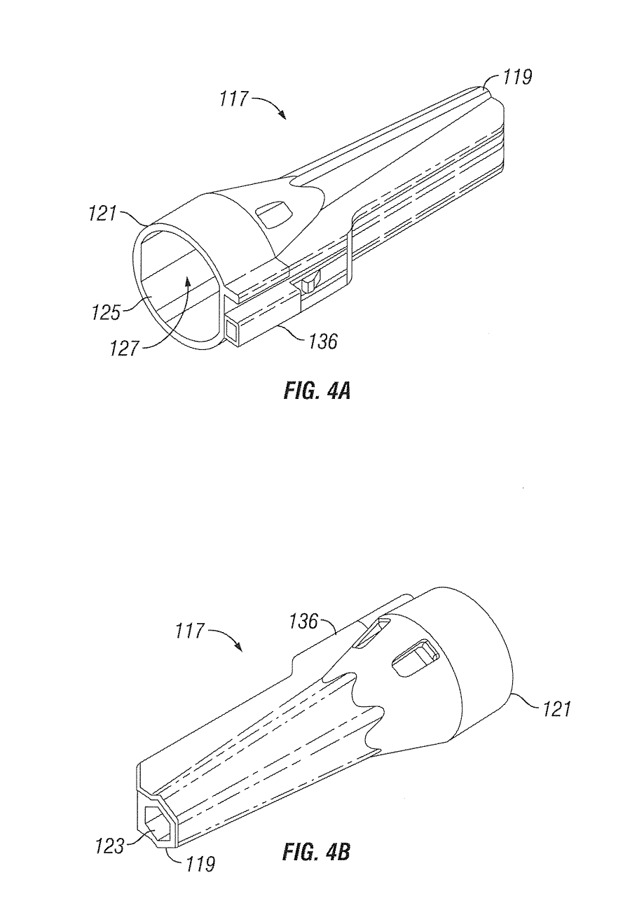

Light emitted from the LED 110 includes one or more colors and passes into the optical prism 112, which is optically coupled to LED 110. The optical prism 112 optically mixes the colors together to produce desired output color or colors. Optical prism 112 ensures that light is dispersed equally and with adequate intensity from the single light source into the multiple optical fibers 114. In the illustrated embodiment, the red, green and blue color signals are mixed and color matched, preferably evenly, producing a consistent and desired color and intensity at the ultimate lighting locations. Fiber connector 122 (best seen in FIGS. 4C-D) optically connects the optical prism 112 and optical fibers 114 and also provides a mechanical connection aligning an optional harness for the optical fibers 114 with the light engine 10 and prism 112. In one embodiment, prism 112 and fiber connector 122 are housed within an optical connector housing 117. LED 110 is connected to optical prism 112, which may in turn be connected to a bundle of fiber optic cables 114 via connector 122. In operation, LED package 110 projects light of one or more colors into optical prism 112.

In a preferred embodiment, the optical cables 114 are plastic fiber optic cables. The even intensity of the light generated makes use of plastic fiber optic cables particularly desirable. Another advantage of the plastic fiber optic cable is that relatively low sidestream loss is achieved. Moreover, in one embodiment, optical cables 114 with accompanying insulating jacket 132 are used to prevent light leakage and provide protection to the plastic optical fiber when routing and attaching in a desired location. An example of a suitable POF cable used is cable having a 2 mm OD with a 1 mm thick jacket, but other diameters and dimensions may be used depending on the desired properties and application.

Although plastic optical fiber is used in a preferred embodiment, any other type of, or combinations of, fiber optic cables can be used that can convey the light from the optical prism to desired locations. For example, cables of various types of plastics and/or glass can be used, or combinations thereof. Glass optical fibers generally are made from silica, but other materials such as fluorozirconate, fluoroaluminate, and chalcogenide glasses may be used for longer-wavelength infrared applications. POF is commonly step-index multimode fiber with a core diameter of 1 mm or larger. POF for transmitting visible light generally include at least a light transmitting core and a cladding. In some embodiments, the core is made of a polymeric material, and the cladding typically made of a fluoropolymer material. POF typically has much higher attenuation than glass fiber, i.e., the amplitude of the signal decreases faster. It has been found that glass optical fibers are relatively heavy and fragile compared to plastic fibers and accordingly plastic is preferred in the present invention.

FIGS. 3A and 3B show a preferred embodiment of a light engine 10 of the ambient lighting assembly. Light engine 10 is illustrated in both an exploded view and assembled and includes module housing 116, which houses the light engine components. Module housing 116 may have a product label positioning region 134 provided on one of its surfaces. The module housing 116 can be of any material and shape suitable for containing and protecting the circuitry, such as an injection molded polymer. LED package 110 is mounted on platform 115 and is optically connected to optical prism 112. Optical prism 112 is disposed within connector housing 117. The connector housing facilitates an optical connection between LED package 110 and optical prism 112. Connector housing 117 could be structured in any manner that would provide a housing for the optical prism, and would vary depending on the type of optical prism used.

Referring to FIGS. 4A-D, in the present embodiment, connector housing 117 comprises a first end 119 and a second end 121 with a first opening 123 at the first end 119 and a second opening 125 at the second end 121. The connector housing 117 defines a passage 127 therethrough and is substantially tapered such that the first end 119 is smaller than the second end 121. As can best be seen in FIG. 4C, optical prism 112 fits snugly within connector housing 117 toward the proximal end 119 so the proximal end of the optical prism is flush with the proximal end of the connector housing. This precise fit positions the inputs of the optical prism 112 for optical connection with LED package 110. Fiber connector 122 is also disposed within connector housing 117 immediately distal to optical prism 112. Thus, the optical prism outputs 154, 172 are in optical connection with fiber connector 122 so light can travel out of the optical prism 112 and be split by fiber connector 122 and distributed to the fiber optic cables 114. In one example, the distal end of fiber connector 122 provides seven receiving apertures 146 to receive seven fiber optic cables 114. Light engine 10 also may include inner crimp 139 and outer crimp 141 to house a portion of plastic optical fibers 114 and facilitate the connection between the fibers and fiber connector 122. The optical connector 117 may optionally have a positive lock assembly 136 to fixedly engage with a portion of recess 133 when the optical connector is inserted into endcap component 118.

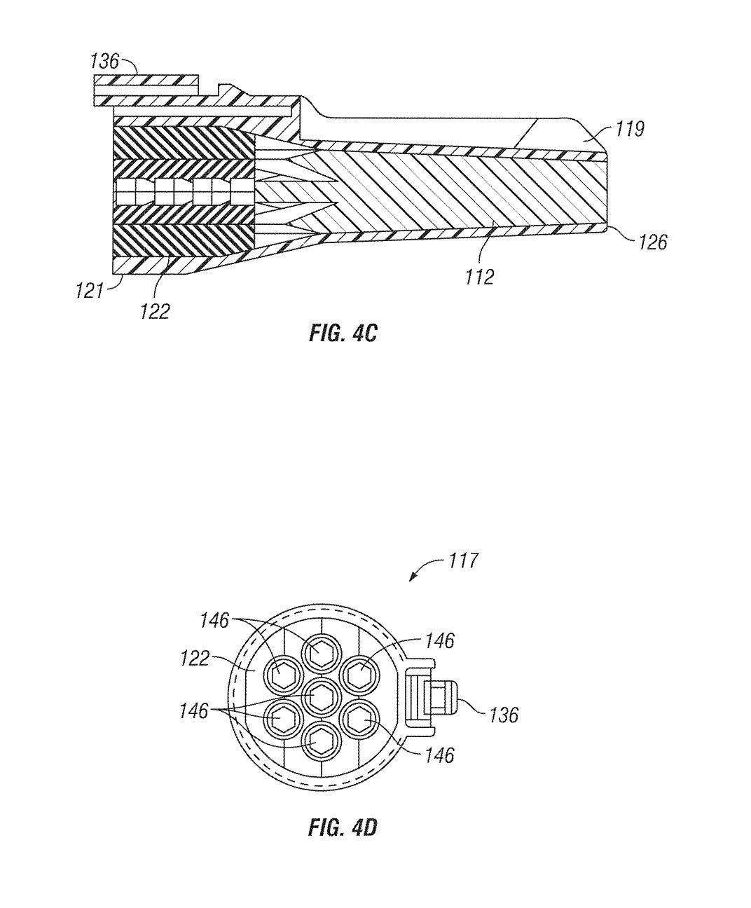

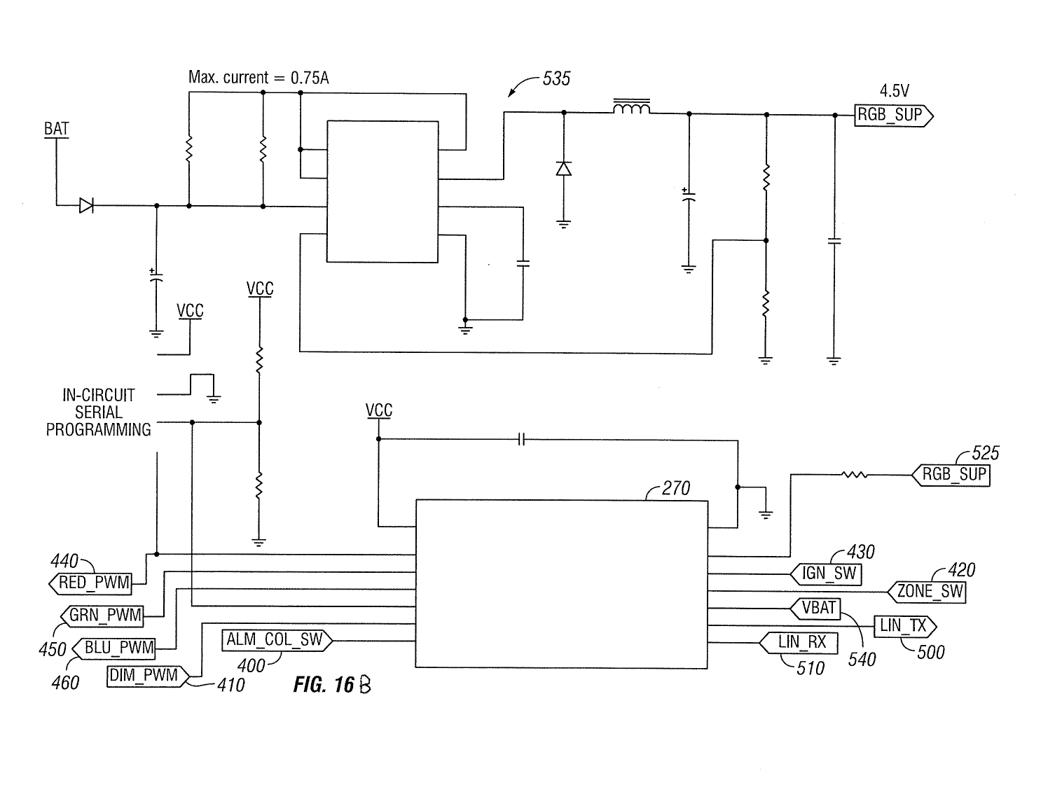

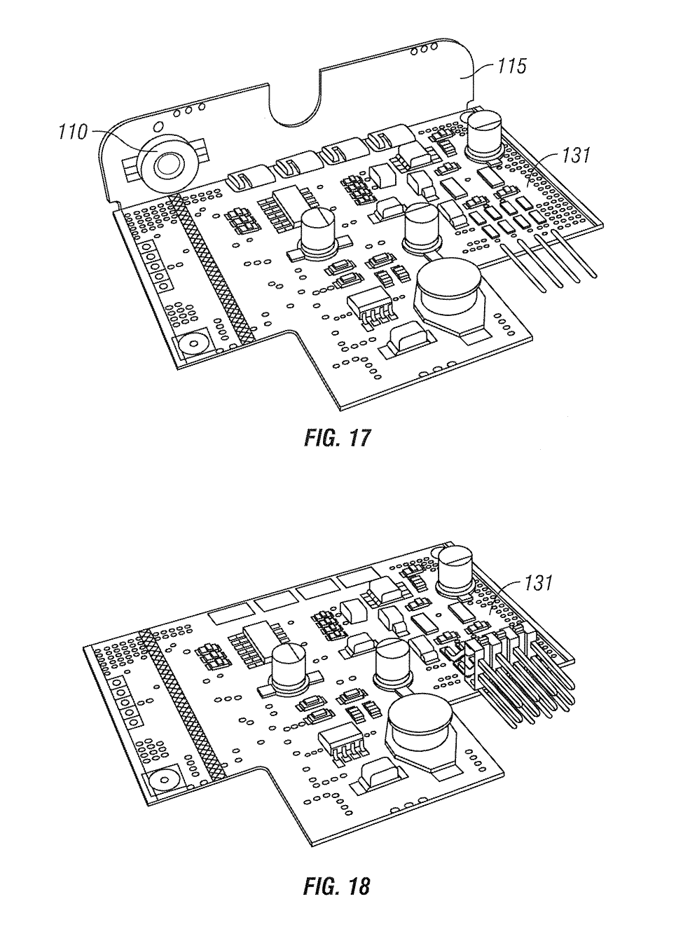

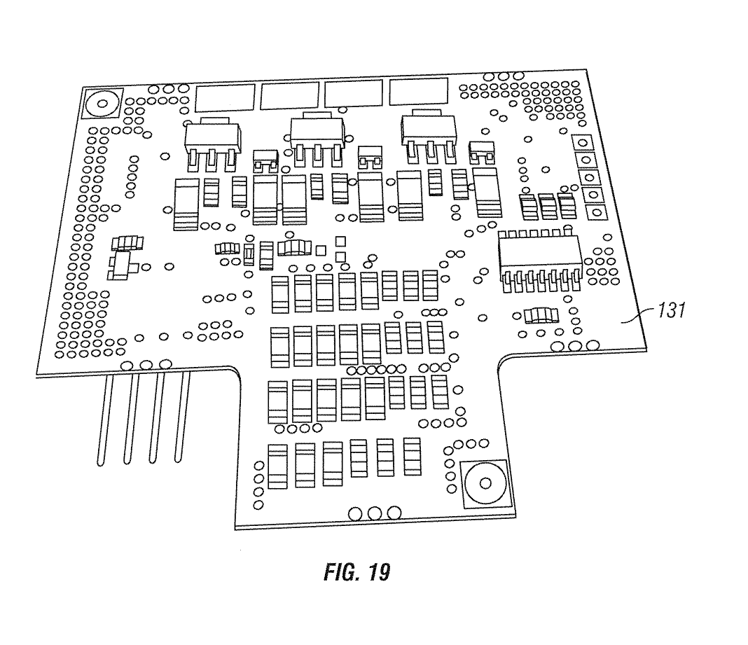

Light engine 10 further comprises circuit board 131 (shown in more detail in FIGS. 17-19) and endcap component 118, which is electrically connected to the circuit board. As can best be seen in FIGS. 5A-D, endcap component 118 preferably defines at least two recesses 133, 135. A third recess 137 may be provided as a location for inserting screws or other fasteners to assist in assembly of the light engine. Recess 133 is shaped to accommodate connector housing 117 such that the connector housing is disposed within recess 133 when the light engine is assembled. Thus, recess 133 is tapered such that its first end 145 is smaller than its second end 147 and the proximal opening is smaller than the distal opening. When connector housing 117 is disposed within recess 133 of endcap component 118 and light engine 10 is fully assembled, optical prism 112 is positioned to be in optical connection with LED package 110. The second recess 135 is configured to provide an electrical connection with circuit board 131. Circuit board 131 can be seen in more detail in FIGS. 17-19, and the circuitry is discussed in detail herein.

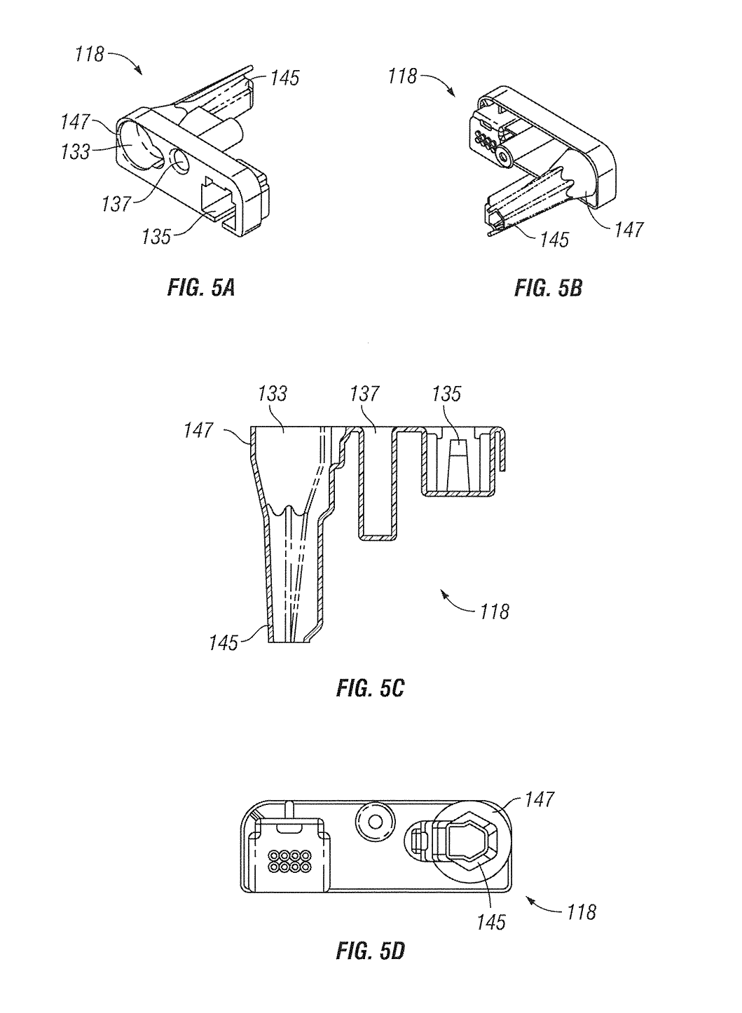

Turning to FIG. 6, an embodiment of the light engine 105 is shown with an alternative embodiment of a module housing. In this example, the module housing is approximately 94 mm wide×60 mm long×21 mm in height, but the dimensions may vary depending on the enclosed volume. Optionally, the housing 216 has a product label positioning region 134 provided on one of its surfaces. The module housing 216 is illustrated as spatially separated from mating module lid 218, but it readily will be appreciated that the housing 216 and lid 218 are connected in an assembled module. Module lid 218 or module housing 216 optionally may include electrical connectors (not shown) or wiring to provide an electrical connection between one or more external circuits and the light engine. Circuit board 84 is provided. Module lid 218 attaches to module housing 216 and may be connected in any fashion, such as a snap fit, hinge, or screw, by way of example. Connector housing 117 is housed in recess 133 such that an optical connection is achieved between optical prism 112 and the LED package 110, which is mechanically connected to panel 82.

Plastic fiber optic cables 114 extend from fiber connector 122. Each plastic fiber optic cable 114 has a directing optic assembly 128 attached to its distal end, as shown in FIG. 2. Within the module housing 216 and module lid 218 assembly the light emitted from the LED is evenly mixed by the optical prism, then sent by the prism outputs through fiber connector 122 to the plastic fiber optic cables 114. The light travels through the cables to the directing optic assemblies (not shown), and emerges from the directing optics, which direct the light and spread the light to illuminate the desired area.

Module lid 218 defines opening 133 into which connector housing 117 fits and allows optical prism 112 to form an optical connection with LED package 110. In one embodiment, opening 133 is a cylindrical recess, to better facilitate the optical connection. The distal end 126 of connector housing 117 is flush with panel 82, and optical prism 112 connects to LED 110 by any mechanism that achieves the desired optical connection. In one example, connector housing 117 an injection molded housing that is sufficiently hard and durable for the environment in which it is used. Some examples are hard, durable plastics such as ABS, PVC, polycarbonate or other polymeric materials or a combination of such materials, but also may be made of other materials such as metal or aluminum. Fiber connector 122 also may be a 7-way connector, but it could have a one way configuration or any other number of connections depending on the desired application. The connector housing 117 may optionally have a positive lock assembly 136 to fixedly engage with a portion of opening 133 when the optical connector is inserted into module lid 218.

In the illustrated embodiment, connector housing 117 houses optical prism 112 and fiber connector 122, although other arrangements may be provided that provide light communication between the LED 110 outputs and optical fibers 114. The position of optical prism 112 within connector housing 117 facilitates connection of the optical prism with LED 110 so the LED emits light into the optical prism 112 as described above. In an embodiment, fiber connector 122 has a taper 142 at its proximal end so it fits into an end of connector housing 117. As illustrated in FIG. 6, optical prism 112 connects to fiber connector 122 at the proximal end of the fiber connector. Fiber connector's distal end is configured to receive one or more plastic fiber optic cables 114, shown here as a seven cable fiber bundle 144. In one example, the distal end of fiber connector 122 defines seven receiving apertures 146 to receive seven fiber optic cables 114. The fiber connector aligns the plastic fiber optic cables with the optical prism to promote light transmission. In an example, POF cables 114 are used, each having an approximately 2 mm diameter. Likewise, fibers of different diameters can be selected depending on the desired application.

The distribution pathway of some embodiments will now be described. Input circuitry 100 providing the characteristics of the desired light output or alternatively other parameters driving the components of the light engine, prism(s) or connector(s) are provided. Examples of light parameters are colors and intensity or location to be lit. The input signals are received within the light engine module 116, that includes a light engine driver assembly 84. The computer processor or controller controlled by on board software receives the input signals from the input circuitry 100, and interprets them as color requests, such as for various zones or features of a vehicle. Light emitted from LED package 110 enters the optical prism 112, and is mixed as desired. Slanted refracting surfaces within the prism refract and mix the light, as described in more detail below. Alternatively, or additionally, the controller or processor can control the mixing operation. The light then exits prism 112 that is contained by the 7-way connector housing. Light is dispersed into the optical bundle that is contained by outer crimp 141 into the one or more plastic fiber optic cables 114.

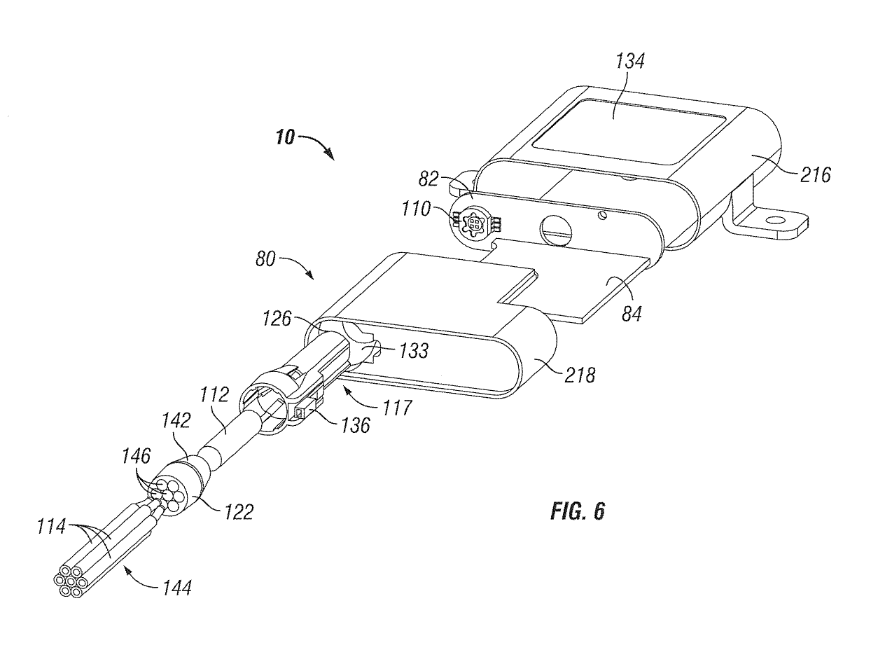

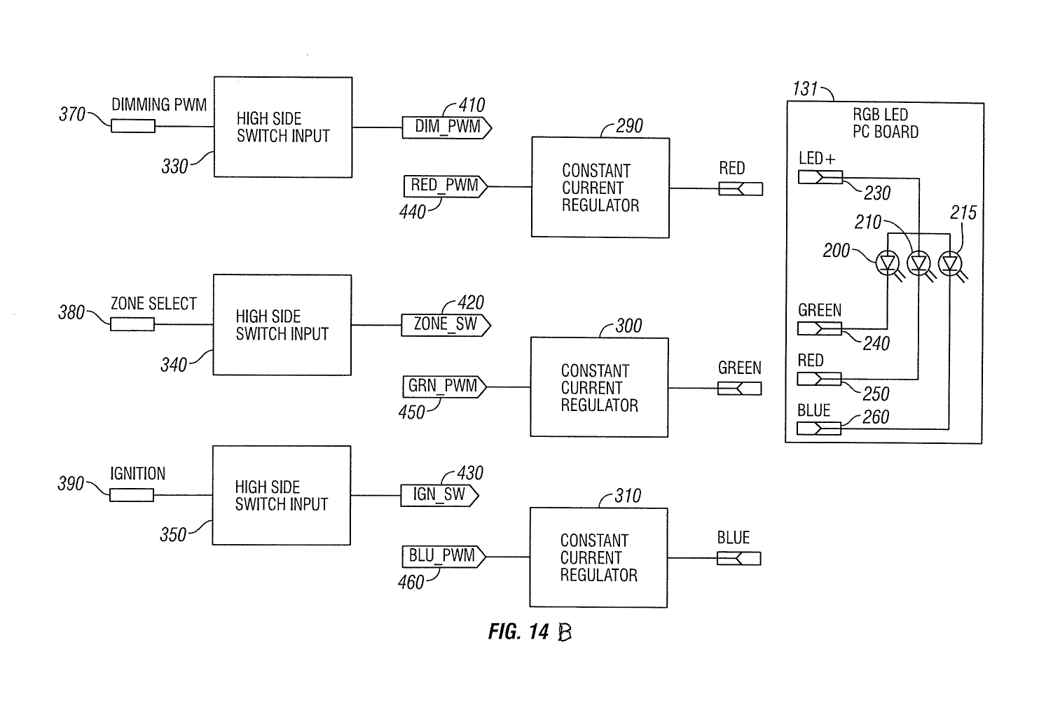

One example of a refracting structure of the optical prism 112 is illustrated in FIGS. 7-12. The optical prism 112 optically mixes colors, to provide a desired even intensity of light, and facilitates the optical connection of the LED package 110 to the multiple strands of plastic fiber optic cable 114. The components of the optical prism 112 may be made of any material providing desired mixing characteristics, although acrylic is the preferred material and substantially 100% acrylic is also preferred. A material is selected that achieves a high transmission of light, i.e. low losses, and it has been found that acrylic can achieve good results, approaching 100% light transmission or throughput. Use of acrylic or similar material is important to minimize light loss from the LED to the distribution end of the optical prism. The prism also may be made of borosilicate crown glass or fused silica, but may be made of other materials known in the art. The prism optionally may have a reflective coating to help reduce the loss of light due to transmission and/or an anti-reflective coating to reduce loss of light due to reflection.

The optical prism 112 may vary in physical dimensions. Certain embodiments have a hexagonal shape, although any other shape that achieves the desired even light intensity and color generation, light loss level, may be used as well. In the hexagonal embodiment, six refracting surfaces 152 are arranged at 60 degree angles from each other, however other shapes and a wide range of angles can be used. The emitted light from the LED 110 is refracted via the refracting surfaces 152 of the optical prism 112. This can have an effect of concentrating and collecting light from all angles. The refraction surfaces also cause the emitted light to be integrated into beams of flat, smooth light, thereby enhancing the brightness of the LED. Generally, the optical prism will have flat, polished sides arranged at precisely controlled angles to one another. At the proximal end 150 of the optical prism 112, in some embodiments, the solid hexagonal structure divides into multiple outputs 154 which send the light through fiber connector 122 (shown in FIG. 3A and 4A-D) and into the fiber optic cables 114 (shown in FIGS. 1 and 2) through fiber bundle 144 (shown in FIG. 6). The embodiment shown in FIGS. 7-12 comprises six external outputs 154 and one center output 172 for a total of seven individual outputs. Outputs 154 and 172 can have individual hexagonally shaped end surfaces 166.

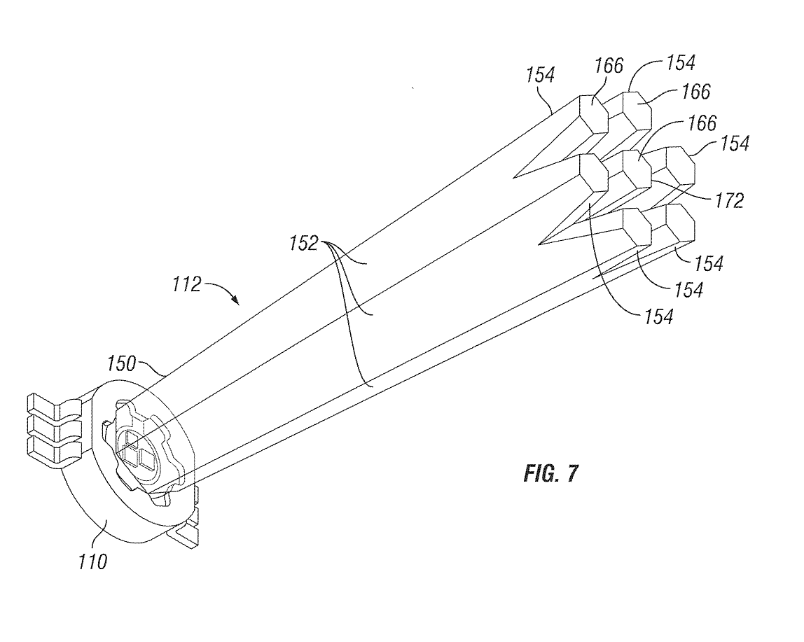

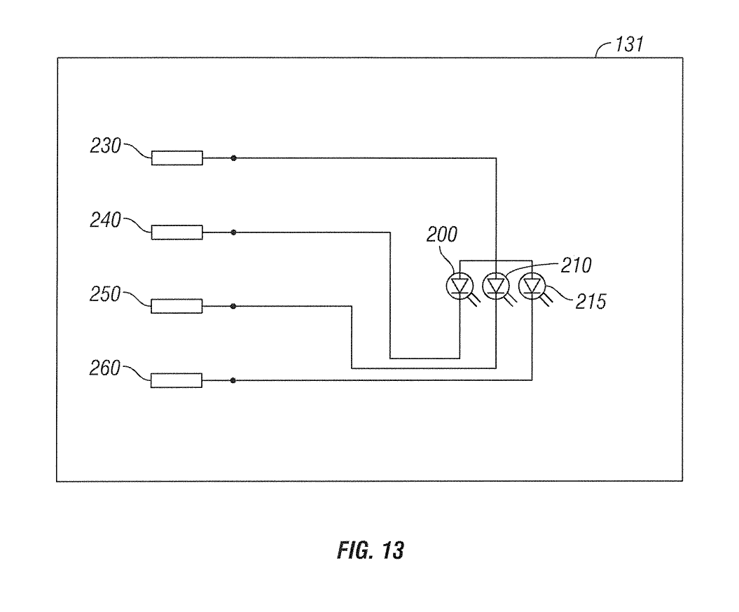

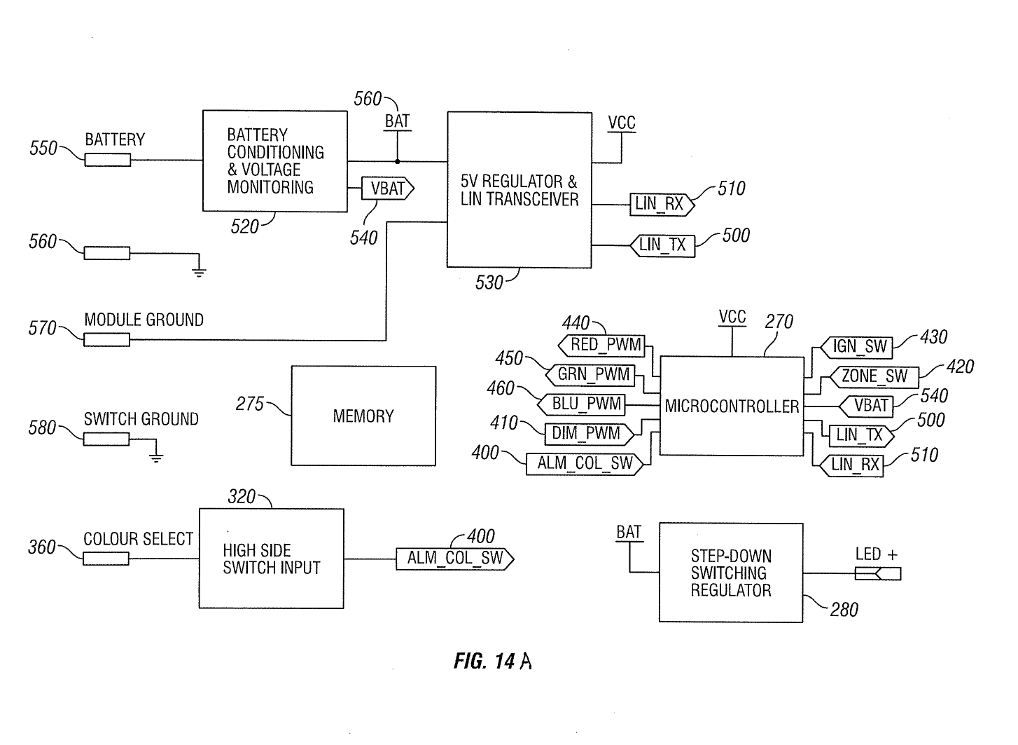

FIG. 8 shows a top view of the optical prism 112 of an embodiment of the invention. In the illustrated embodiment, the sides taper very slightly at a 6 degree angle from the distal end to the proximal end. Each edge of each individual output 154 at the distal end has a 20 degree angle from the center of the prism, marked here as line A-A. The input surface 162 measures a diameter of 0.194 inches but may be other diameters depending on the application. A side view of the optical prism can be seen in FIG. 6, and a sectional view of the prism cut along section B-B can be seen in FIG. 11. Outputs 154 are defined by cut angular channels 164 around the exterior of the prism that separate the individual outputs from each other. Interior angular channels 168 also separate internal sides 170 of the outside six outputs 154 from the one center output 172. As shown in FIGS. 10 and 11, in a preferred design interior channels 168 extend deeper into the optical prism in the proximal direction than exterior angular channels 164.

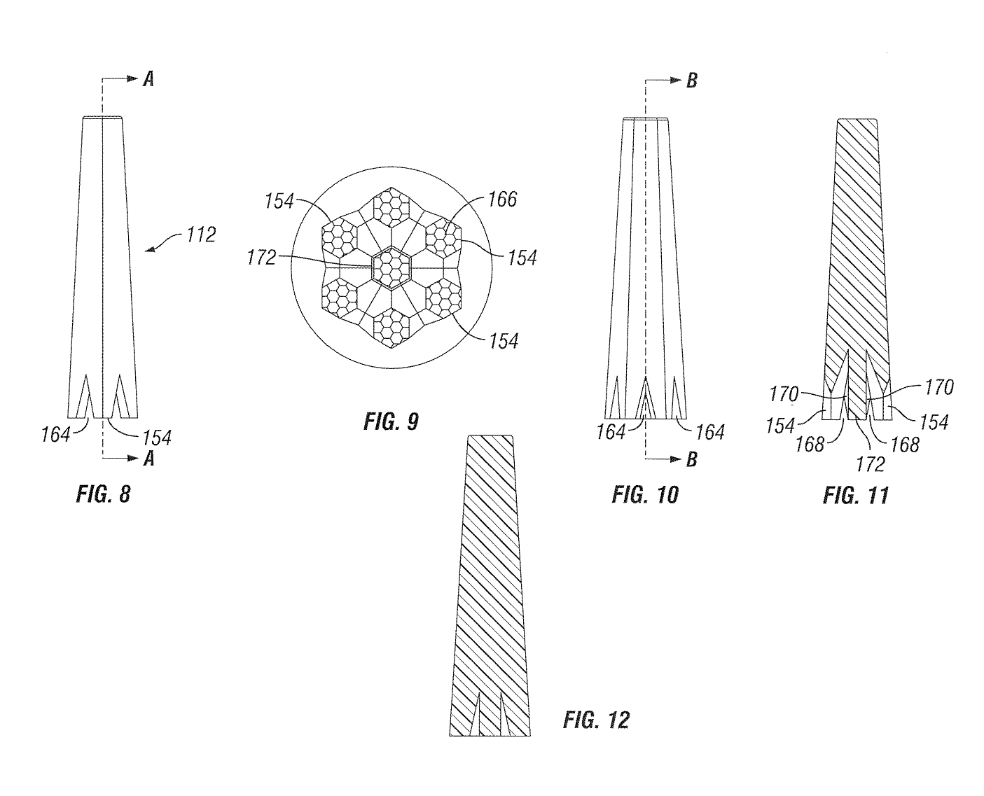

FIG. 9 shows a front view of the distal end of the optical prism. Individual outside outputs 154 are arranged in a ring around one center output 172. In the embodiment shown here, each output surface 166 has a hexagonal shape. This structure optimizes refraction and mixing of emitted light, and allows the light to be concentrated and collected from all angles. As discussed above, the output surfaces mate with the fiber connector to transfer the light into the fiber optic cables.

By changing the shape and number of the refractive surfaces of the optical prism, the mixing and dispersal of light may be controlled. In other embodiments, different shapes can be used, along with a different number of refracting surfaces and various angles. Furthermore, any number of outputs can be used, depending on the desired application. As would be apparent to one of skill in the art, the number of prism outputs would correspond to the number of fiber optic cables used in a particular application so the light can be evenly dispersed through the cables. Some common applications include three prism outputs and three fiber optic cables, 19 prism outputs and 19 cables, and as described above, seven prism outputs and seven cables, but other numbers may be used.

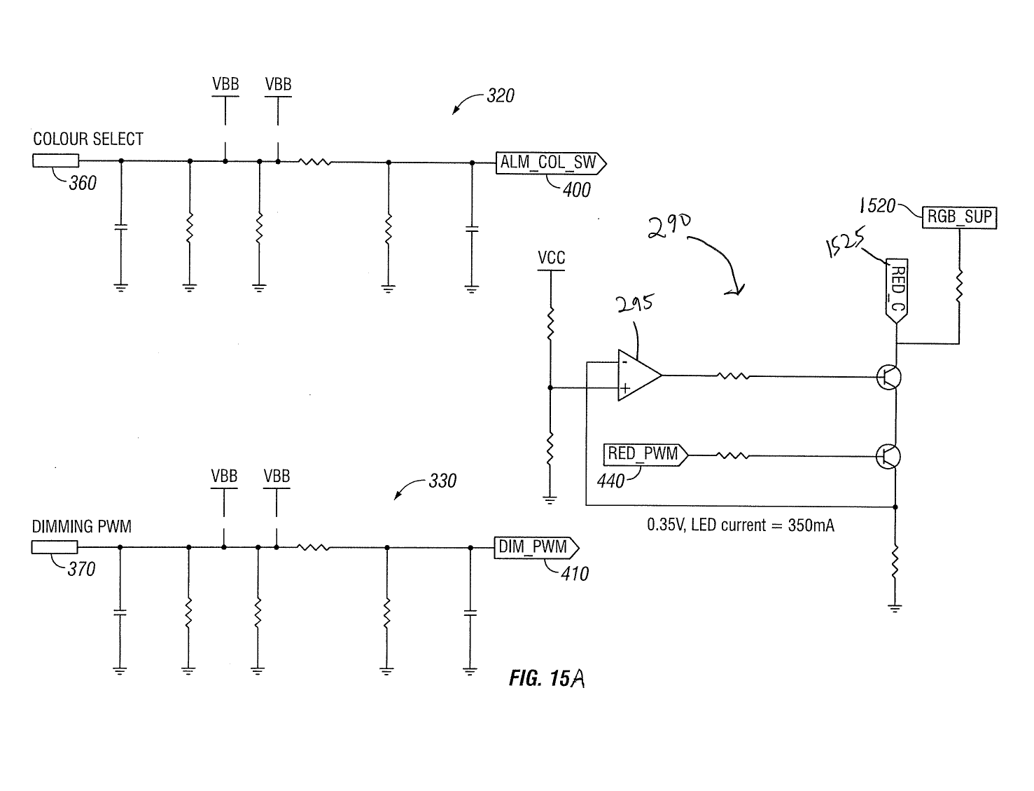

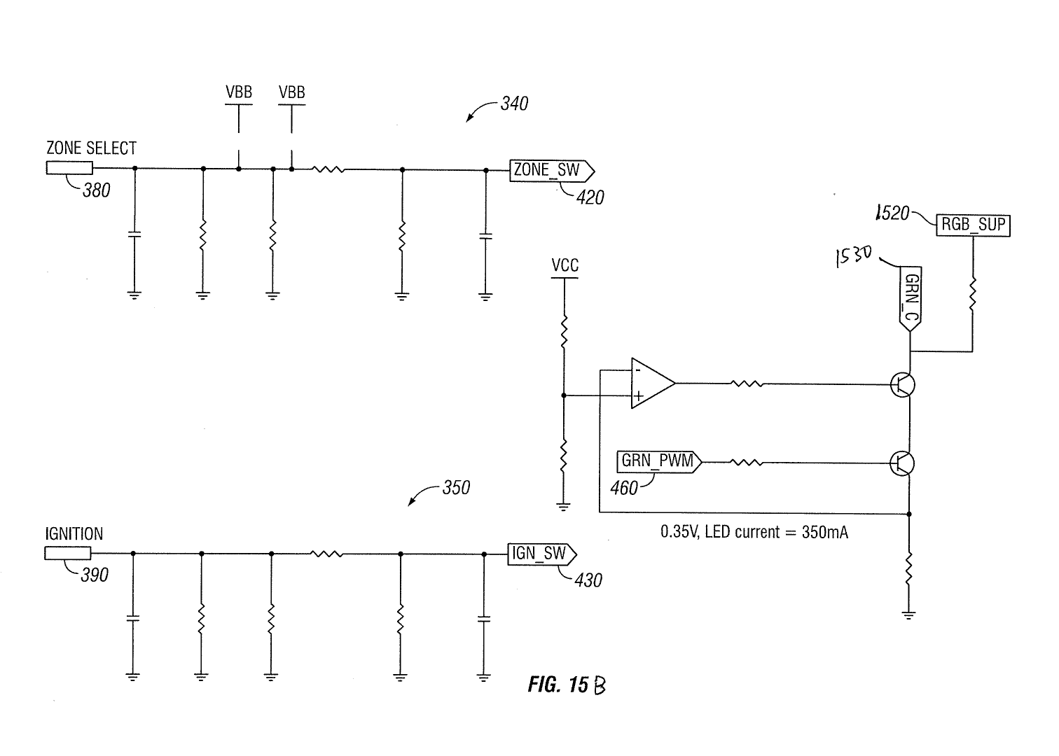

Turning to FIGS. 13-16B, the internal electronic circuitry of light engine 10 is shown in circuit diagrams, and in perspective drawings in FIGS. 17-19. FIG. 13 is a circuit diagram illustrating a preferred red-green-blue LED board, with green LED 200, red TED 210 and blue LED 215. LED+ contact 230 passes on signals to the color LEDs, which emit the appropriate color output via green contact 240, red contact 250 and blue contact 260. FIG. 14 is a block schematic of the ambient lighting system's input circuitry. In an embodiment of the invention in which a vehicle lighting system is provided, the inputs may include, but are not limited to, inputs from the ignition, a battery, a network controller, a color select, a zone select, a door input and a dimmer input. These various inputs can control the desired light output. As one example, an ignition input may drive a desired signal light on a dashboard or in the cabin interior. There also may be one or more switch inputs that designate a desired output color for different zones in a vehicle, such as the front, roof, back, glove compartment and any other desired zone.

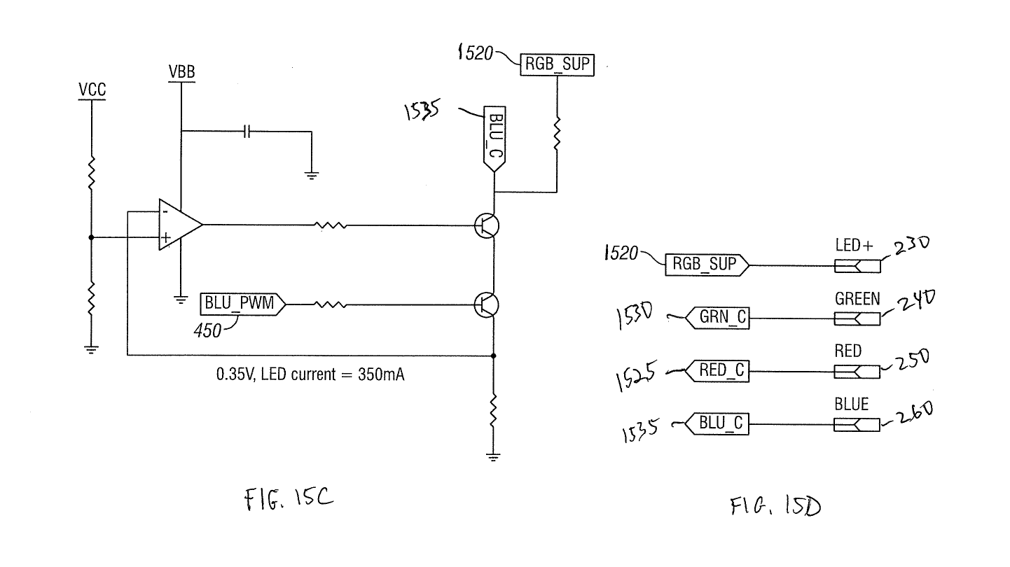

Some of the potential inputs are shown in FIGS. 14A-B, including a color select contact 360 and color select switch input 320, a dimming contact 370 and dimming switch input 330, a zone select contact 380 and zone select switch input 340, and an ignition contact 390 and ignition switch input 350. Memory 275 also can be seen in FIG. 14A. Memory 275 can be random access memory (RAM) and/or electrically erasable programmable read-only memory (EEPROM) or any external memory sufficient to hold the software code including but not limited to semiconductor memory, flash memory, or magnetic storage. The internal circuitry of the switch inputs is shown in more detail in FIGS. 15A-C. The preferred wiring, grounding and placement of resistors are illustrated for color select switch input 320, dimming switch input 330, zone select switch input 340 and ignition switch input 350.

Referring to FIGS. 14A-B and 15A-C, the lighting is controlled by a microprocessor-based controller that pulse width modulates (PWM) the voltage to produce various colors. The control signals from the various switch inputs communicate with this microcontroller 270. Thus, the color select signal 400, the dimmer signal 410, the zone select signal 420 and the ignition signal 430 can be seen traveling from their respective switch inputs as signals to the microcontroller 270. Microcontroller 270 then emits pulse width modulations for the desired color wavelengths, e.g., red pulse width modulation 440, green pulse width modulation 450 and blue pulse width modulation 460, to current regulators 290, 300 and 310. Step-down switching regulator 280 converts vehicle battery voltage (typically around 12v) to a common electronics voltage level (typically around 5v) that is needed to power microcontroller 270 and other electronics. A feedback loop is provided between current regulators 290, 300 and 310 and microcontroller 270, that is, PWM voltage is fed back to the microcontroller, to maintain a constant current output. The internal circuitry of current regulators 290, 300 and 310 can be seen in more detail in FIGS. 15A-C, including an operational amplifier 295. Some of the internal lighting circuitry includes RGB_SUP 1520, RED_C 1525, GRN_C 1530 and BLU_C 1535. Specifically, the preferred wiring and layout of resistors and amplifiers are shown. The appropriate current is then sent to circuit board 131, through the edge connectors on the circuit board, specifically green edge connector 240, red edge connector 250, and blue edge connector 260. The signal is received by the LED package 110, which includes green LED 200, red LED 210 and blue LED 215.

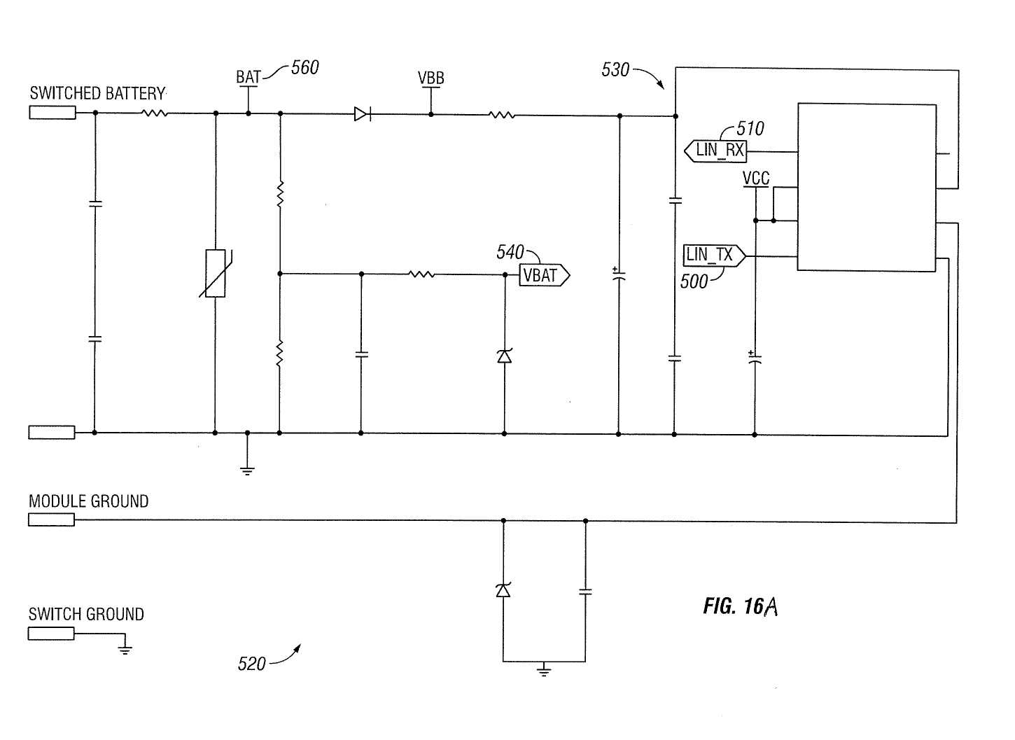

FIGS. 14A-B also show the voltage monitoring components and connections in block form. These include battery conditioning and voltage monitoring component 520 and regulator/transceiver 530. Battery 560 is connected to those components. Battery contact 550 provides an input and there is a VBAT 540 output signal. LIN TX 500 and LIN RX 510 are used for additional modules that can be used in a system having multiple zones, such as where separate rear passenger lighting is required. The internal circuitry of the voltage monitoring components is shown in more detail in FIGS. 16A-B. The preferred arrangement of internal wiring, capacitors and resistors for battery conditioning and voltage monitoring component 520 and regulator/transceiver 530 can be seen.

Microcontroller 270 also can be seen in FIG. 16B with some of the connections to the switch inputs shown in more detail. Pin connects for the inputs to microcontroller 270 are provided. These include color input signal 400, dimmer input signal 410, the zone input signal 420 and ignition input signal 430, as well as a LIN RX signal 510, a VBAT signal 540 and an RGB SUP input 525. The preferred output arrangement from the microcontroller also can be seen. The outputs include LIN TX signal 500 and red pulse width modulation 440, green pulse width modulation 450 and blue pulse width modulation 460. The input circuitry of the light engine includes connections comprising a wide range of vehicle functions. Depending on the application, inputs can be connected to different signal generating inputs that provide sufficient information to drive the light engine 10 to generate a desired light output. In stand alone mode, the input circuitry 100 provides different inputs to light engine 10 to generate a desired light intensity or color outputs using the light output of its on-board LED. FIG. 16B shows voltage regulator 535 for the internal circuitry. In Master/Slave operation, discussed in detail below, the light engine also provides desired voltage and current regulation, timing regulation or digital control to the LEDs through LIN, CAN or any other suitable type of communications.

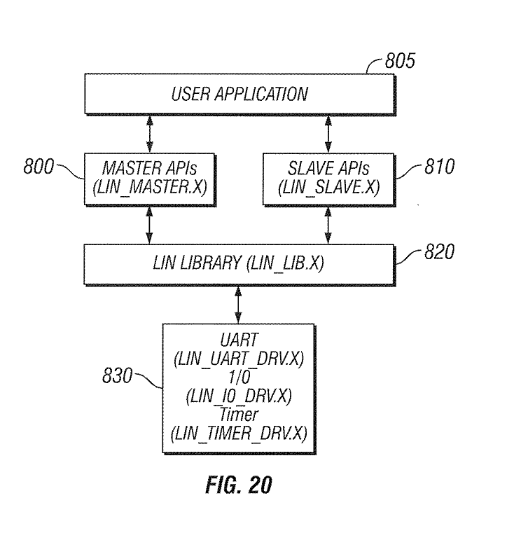

Internal software reads the inputs or color requests, and the internal circuitry of the light engine provides control over the LEDs as well as voltage and current regulation. The software comprises a Master module and a Slave Module. Preferably, only one Master module is provided. Multiple Slave modules (up to about 16) can be used. The Master and Slave modules preferably communicate in standard Local Interconnect (LIN) network, but Controller Area Network (CAN) also would work. The Master and Slave application software may sit in random access memory (RAM) and/or electrically erasable programmable read-only memory (EEPROM). However, it will be apparent to those of skill in the art that any external memory sufficient to hold the software code may be used, including but not limited to RAM, EEPROM, semiconductor memory, flash memory or magnetic storage. The software code preferably is written in C language, but other languages also would suffice. Preferably, the software uses values for timing on an 8 MHz oscillator. Three software layers have been defined for embodiments of the present invention. The three layers are shown in FIG. 20, with the highest level being the Master APIs 800 and Slave APIs 810, the middle level being the LIN library 820, with the lowest level the UART and Timer 830. User application 805 communicates with the Master and Slave APIs.

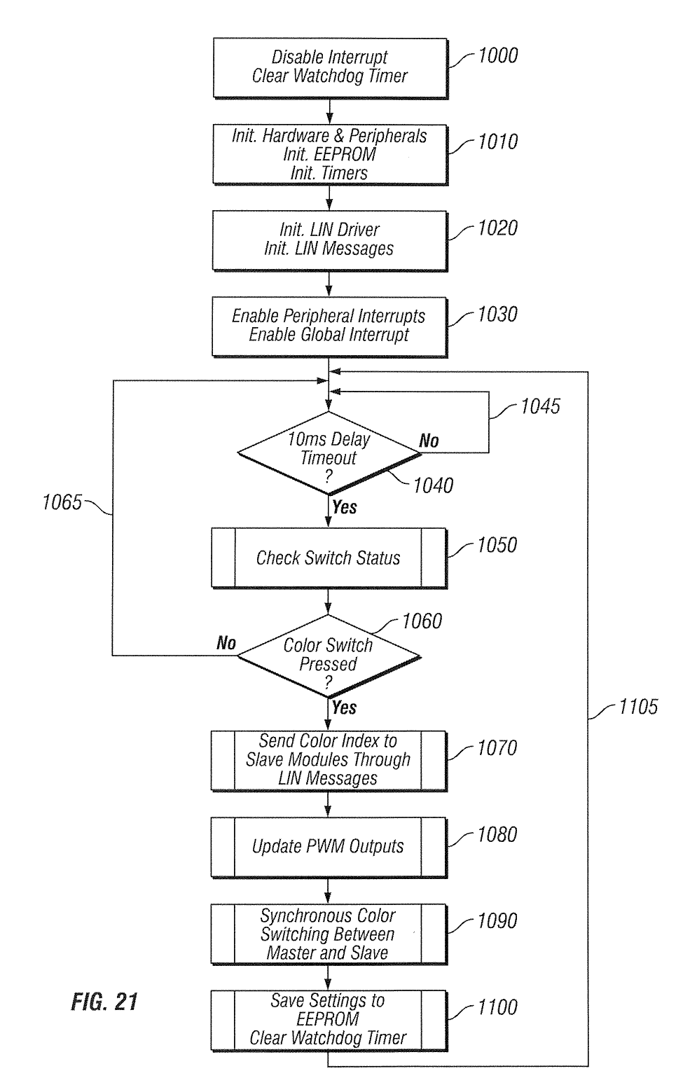

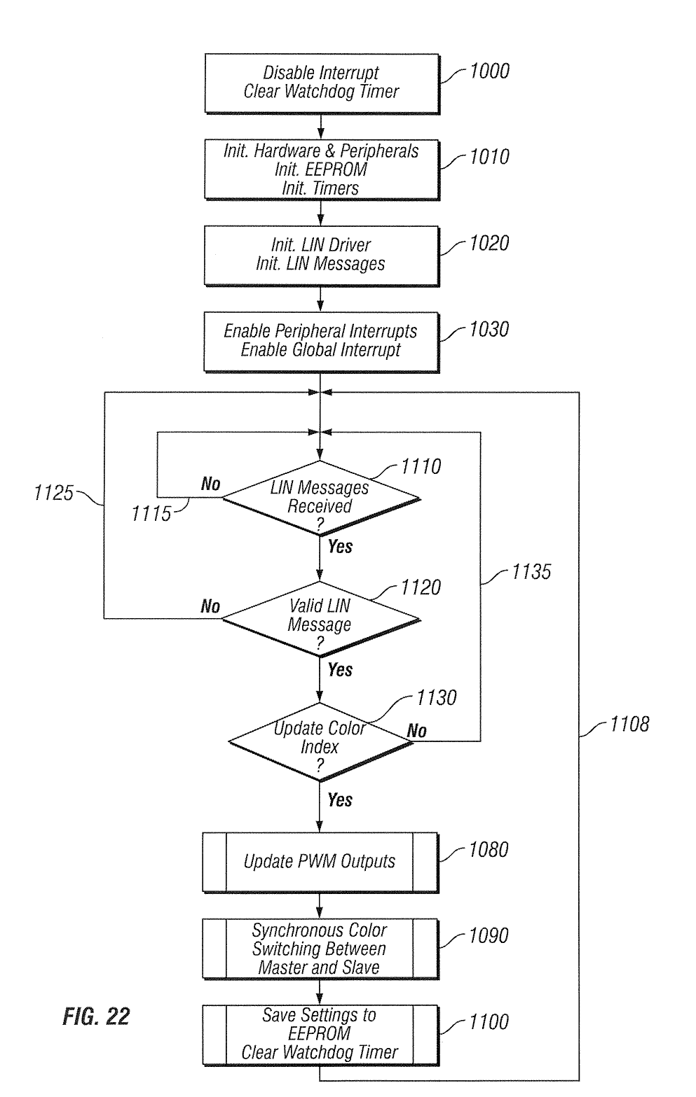

The software flow diagram for the Master module is shown in FIG. 21, and the software flow diagram for the one or more Slave modules can be seen in FIG. 22. The microprocessor 270 (shown in FIG. 14) manages communications between modules and can route tasks to the Master Module for delegating to the other modules or to both the Master Module and the one or more Slave Modules directly. The Master module provides voltage and current regulation, timing regulation or digital control to the LEDs through LIN, CAN or any other suitable type of communications. The flow diagrams here show LIN communication.

In a preferred embodiment, the Disable Interrupt/Clear Watchdog Timer step 1000 is the first step of the process. In the next step 1010, the software Initiates Hardware & Peripherals, Initiates EEPROM and Initiates Timers. Another initiation step is the Initiation of the LIN Driver/Initiation of LIN Messages 1020. Next, in step 1030, the software Enables Peripheral Interrupts and Global Interrupts. In the Master Diagram in FIG. 21, there is next a decision step 1040 to determine if there should be a 10 ms Delay Timeout. If the inquiry to decision step 1040 is negative, the “No” branch 1045 is followed, the inquiry is repeated and the software again determines if a 10 ms Delay Timeout 1040 is necessary. If inquiry to decision step 1040 is positive, the next steps are to determine the Check Switch Status 1050 and determine if the Color Switch is Pressed 1060. If the color switch is not pressed, then the “No” branch 1065 is followed to decision step 1040 and the software again determines if a 10 ms Delay Timeout 1040 is necessary. If the color switch is pressed, the Master Module performs sending step 1070—Send Color Index to Slave Modules Through LIN Messages. Next, the Master Module issues the command to Update PWM Outputs 1080. Then there is the Synchronous Color Switching Between Master and Slave step 1090, and the final step 1100 is to Save Settings to EEPROM and Clear the Watchdog Timer 1100. The system then follows loop 1105 back to the determination of a 10 ms Delay Timeout 1040.

The one or more Slave Modules may receive commands from the Master Module or directly from the microprocessor. As can be seen in FIG. 22, the Slave Module may carry out some of the same tasks as the Master Module. For example, the Disable Interrupt/Clear Watchdog Timer step 1000 may be the first step of the process. In the next step 1010, the software Initiates Hardware & Peripherals, Initiates EEPROM and Initiates Timers. Another initiation step is the Initiation of the LIN Driver/Initiation of LIN Messages 1020. Next, in step 1030, the Slave Module may Enable Peripheral Interrupts and Global Interrupts.

At this point, the Slave Module performs inquiry step 1110 and asks if LIN messages have been received. If the answer to the inquiry is negative, then the “No” branch 1115 is followed and inquiry step 1110 is repeated. If the answer to the inquiry is positive, the Slave Module performs inquiry step 1120 and asks if the LIN message is valid. If the answer to inquiry step 1120 is negative, then the “No” branch 1125 is followed and inquiry step 1110 is repeated. If the answer to inquiry step 1120 is positive, then the Slave Module performs inquiry step 1130 and asks if the Color Index should be updated. If the answer to inquiry step 1130 is negative, then the “No” branch 1135 is followed and inquiry step 1110 is repeated. If the answer to inquiry step 1130 is positive, then the “Yes” branch is followed, and the Slave Module performs step 1080 and updates the PWM outputs. Next, there is the Synchronous Color Switching Between Master and Slave step 1090, and the final step 1100 is to Save Settings to EEPROM and Clear the Watchdog Timer 1100. The system then follows loop 1108 back to inquiry step 1110 to inquire again whether LIN messages have been received.

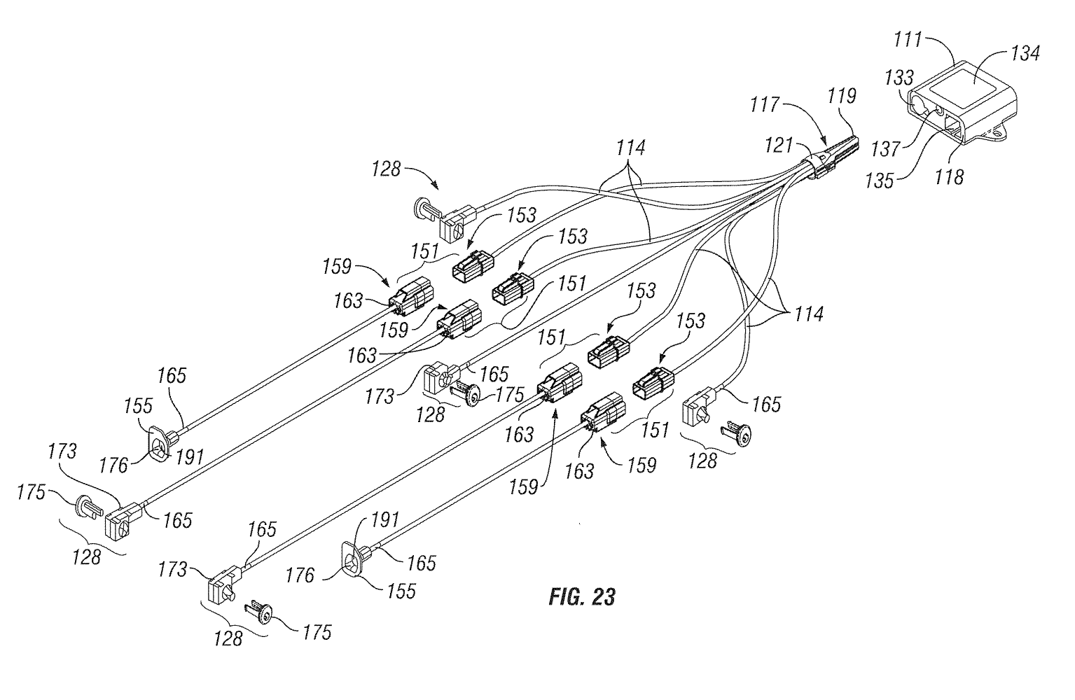

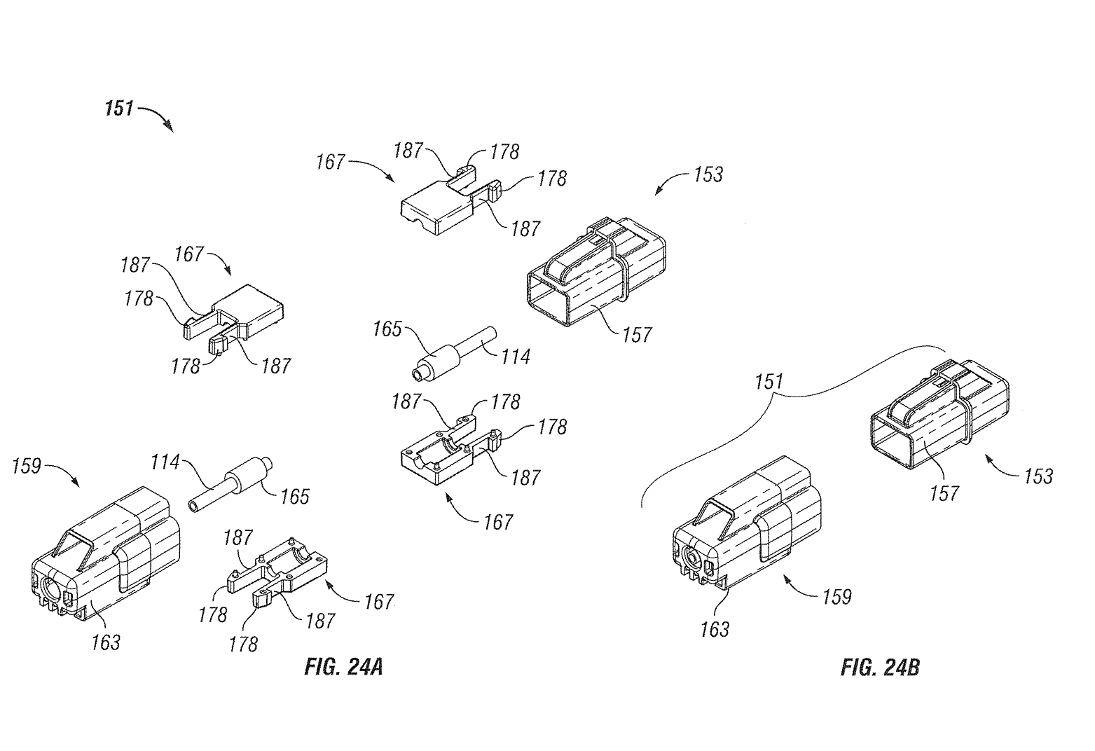

Turning to FIG. 23, the routing of POF 114 can be seen, including cable connector assembly 151, panel cutouts 155 and directing optic assemblies 128. FIGS. 24A and 24B show cable connector assembly 151 in more detail. Cable connector assembly 151 comprises a male connector component 153. Male connector component 153 preferably has a plug shell 157. A female connector component 159 preferably has a header shell 163. Plug shell 157 of the male connector component 153 is configured for insertion and mechanical connection with female connector component 159. A crimp barrel 165 is provided and defines a passage therethrough so a plastic optical fiber may inserted through it. A retainer element 167 also is provided, and crimp barrel 165 is housed in the retainer element. Retainer element 167 may be housed in either the first component 153 or the second component 159 such that the plastic optical fiber runs through one of the components. Retainer 167 has two spring beams 187 that extend from the body of the retainer and each spring beam has a hook 178 at the end. Hooks 178 serve to retain the crimped plastic optical fiber 114 inside the connector components. In addition, hooks 178 interface with first and second components 153, 159 to load spring beams 187 and convert that loading into a force in the direction of connector mating. Hooked extensions 178 help secure retainer element 167 in the module connector assembly housing. The plastic optical fiber 114 with a crimp barrel 165 on it nests in the retainer element 167, fitting snugly because the shape of the crimp barrel is designed to correspond to the internal surface of the retainer element.

The cable connector assemblies 151 facilitate routing of POF 114 in a multi-piece assembly, for example in vehicle assembly lines where assemblies such as a console piece and a dash piece arrive at different stages in the manufacturing process. Specifically, cable connector assembly 151 allows for the POF to be partially assembled in sub-consoles and later fully connected to create a continuous POF strand. It should be noted that the preferred operating voltage is between approximately 9 VDC and 16 VDC.

In vehicles employing embodiments of the present invention, routing of the plastic optical fiber 114 is on the back side of the vehicle body panels. Preferably, vehicle panels are equipped with panel cutouts 155 for purposes of attaching the POF light output ends to the interior of the vehicle and facilitating optic feedthrough. At the location of these panel cutouts 155, POF 114 is terminated with a polished end and fitted with crimp barrel 165. Panel cutout 155 has a recess 176, in which an end of the directing optic assembly 128 may fit and a cutout hole 191 for the bezel assembly 175 of the directing optic assembly 128 to pass through.

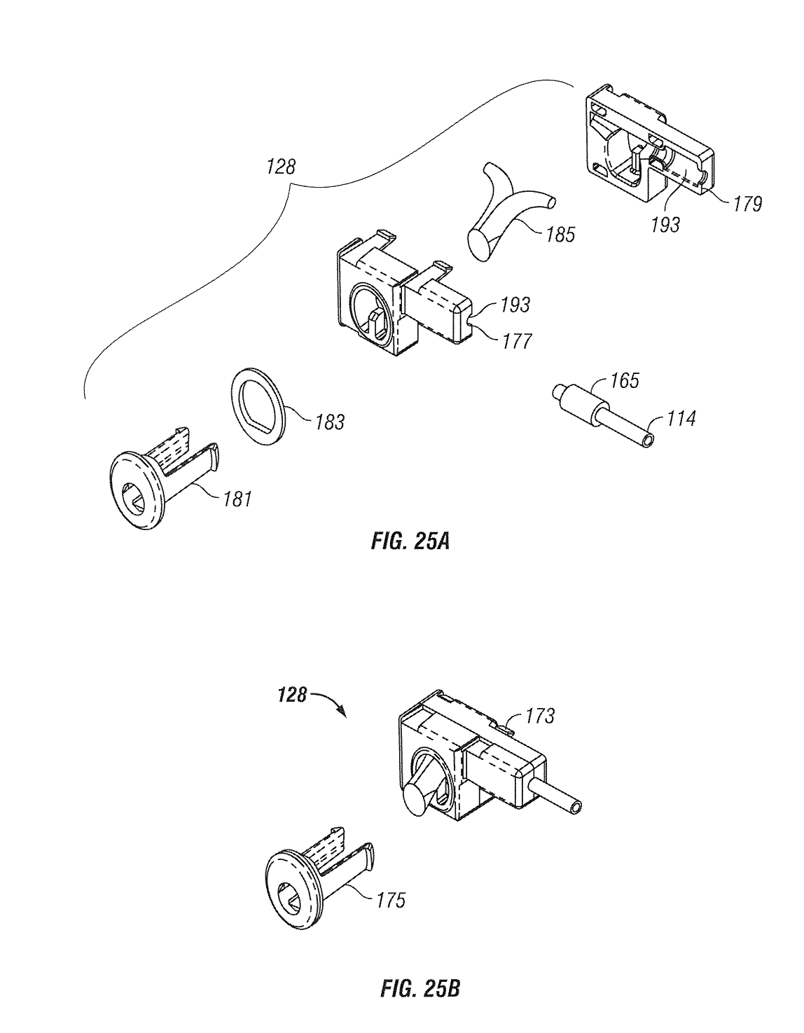

FIGS. 25A and 25B show the directing optic assembly 128 in more detail. Light output from the distal ends of the POF 114 is coupled to the directing optic assemblies 128 to redirect light to the required direction of illumination. Directing optic assembly 128 comprises an emitter assembly 173 and a bezel assembly 175. Emitter assembly 173 includes a first housing component 177 and a second housing component 179. Bezel assembly 175 surrounds the output of the directing optic and includes bezel 181 and gasket 183, which slides onto bezel 181 during assembly. Bezel 181 also passes through the cutout hole in the body panel, fastening to the housing by means of snaps, thereby holding the assembly in place on the vehicle body panel. Bezel 181 is fitted with gasket 183 to prevent leakage of light in unwanted directions and to accommodate variations in vehicle body panel thickness. A crimp barrel 165 also is provided and defines a hole therethrough. As discussed above, with reference to the cable connector assembly, crimp barrel 165 is attached to the end of POF 114. First and second housing components 177, 179 have interior portions 193 configured to receive crimp barrel 165 such that optic lens 185 and the POF with the crimp barrel 165 are held together in the housing. The housing with the directing optic is located on the hidden side of a vehicle body panel. Optic lens 185 transmits and directs light to the area to be illuminated. The optic lens 185 can be made of any appropriate glass or transparent plastic material known in the art.

Thus, it is seen that a lighting system and method of delivering ambient light is provided. It should be understood that any of the foregoing configurations and specialized components may be interchangeably used with any of the systems of the preceding embodiments. Illustrative embodiments of the present invention are described hereinabove, and it will be evident to one skilled in the art that various changes and modifications may be made therein without departing from the invention. It is intended in the appended claims to cover all such changes and modifications that fall within the true spirit and scope of the invention.

What is claimed is:

1. An optical prism comprising:
a first end adapted for input of light;
a second end adapted for output of light;
a plurality of sides forming a solid geometric structure, the sides arranged at controlled angles to one another and having refracting surfaces to mix light; and
a plurality of outputs at the second end of the optical prism to split light such that the light can be transmitted via a plurality of separate optic cables.

2. The optical prism of claim 1 wherein the prism has six sides and the geometric structure is a hexagon.

3. The optical prism of claim 2 wherein the prism has seven outputs.

4. The optical prism of claim 3 wherein the seven outputs comprise six outputs arranged in a ring around one center output.

5. A lighting system comprising:
a light engine, having at least one light-emitting diode which emits light comprising one or more colors and an optical prism in optical connection with the at least one light-emitting diode;
one or more plastic fiber optic cables in optical connection with the optical prism and in electrical connection with the light engine, each cable having a proximal end and a distal end; and
one or more directing optic assemblies connected to the distal ends of the one or more plastic fiber optic cables, wherein the directing optic assemblies spread and direct light from the at least one light-emitting diode.

6. The lighting system of claim 5 wherein the light engine further comprises:
a circuit board;
an endcap component in electrical connection with the circuit board, the endcap component defining at least two recesses;
a connector housing to connect the at least one light-emitting diode to the optical prism, the optical prism disposed within the connector housing, and the connector housing disposed within one of the recesses of the endcap component;
a fiber connector configured to receive the proximal ends of the one or more plastic fiber optic cables and to align the plastic fiber optic cables with the outputs of the optical prism, the fiber connector disposed within the connector housing distal to the optical prism; and
a module housing;
wherein the light-emitting diode, the circuit board, the endcap component, the connector housing and the fiber connector are housed within the module housing.

7. The lighting system of claim 5 wherein the optical prism is configured to evenly mix the colors emitted by the light-emitting diode and to provide even light intensity.

8. The lighting system of claim 6 further comprising a plurality of inputs for the light engine, which comprise one or more of: an ignition input, a battery input, a network input, a color select, a zone select, a door input, and a dimmer input.

9. The lighting system of claim 5 wherein the optical prism is composed of a material that allows substantially all light to be transmitted with little or no light loss.

10. The lighting system of claim 6 further comprising one or more cable connector assemblies.

11. The lighting system of claim 6 wherein the one or more plastic fiber optic cables comprise a bundle of seven fiber optic cables; and
the optical prism comprises seven outputs to split the light such that the light can be transmitted via the fiber optic cables.

12. The lighting system of claim 11 wherein the seven outputs comprise six outputs arranged in a ring around one center output.

13. The lighting system of claim 11 wherein the optical prism has six sides.

14. The lighting system of claim 6 wherein the connector housing comprises two ends and an opening at each end, the connector housing defining a passage therethrough and being substantially tapered such that the second end is smaller than the first end.

15. The lighting system of claim 6 wherein the connector housing is configured to house a fiber connector distal to the optical prism.

16. The lighting system of claim 5 wherein the light directing optics comprise:
an emitter assembly including a first housing component, a second housing component, a crimp barrel and an optic lens;
a bezel assembly including a bezel and a gasket; and
a crimp barrel defining a hole therethrough.

17. A cable connector assembly comprising:
a male connector component;
a female connector component;
at least one retainer element having one or more spring beams and a hook element at the end of each spring beam; and
at least one crimp barrel defining a passage therethrough;
the male connector component configured for insertion and mechanical connection with the female connector component.

18. The cable connector assembly of claim 17 wherein the male connector component comprises a plug shell, and the female connector component comprises a header shell, the plug shell configured for insertion and mechanical connection with the header shell.

19. The cable connector assembly of claim 18 wherein a first length of plastic optical fiber is inserted through the passage of a first crimp barrel, and a second length of plastic optical fiber is inserted through the passage of a second crimp barrel; and
the first crimp barrel is nested in a first retainer element, and the second crimp barrel is nested in a second retainer element.

20. The cable connector assembly of claim 19 wherein the first retainer element is housed in the male connector component, the second retainer element is housed in the female connector component, and the hook elements retain the plastic optical fiber inside the connector components such that the first and second lengths of fiber optic cable are optically connected and routed through the cable connector assembly.
